(19) United States
(12) Patent Application Publication
(10) Pub. No.: US 2017/0246948 A1
(43) Pub. Date: Aug. 31, 2017

(54) METHOD FOR STARTING AN INTERNAL COMBUSTION ENGINE OF A HYBRID VEHICLE

(71) Applicant: SCHAEFFLER TECHNOLOGIES AG & CO. KG, Herzogenaurach (DE)

(72) Inventor: Michael REUSCHEL, Ottersweier (DE)

(73) Assignee: Schaeffler Technologies AG & Co. KG, Herzogenaurach (DE)

(21) Appl. No.: 15/521,778

(22) PCT Filed: Nov. 20, 2015
(86) PCT No.: PCT/DE2015/200511

§ 371 Date: Apr. 25, 2017

(30) Foreign Application Priority Data
Nov. 28, 2014 (DE) 10 2014 224 391.2

(51) Int. Cl. B60K 6/48; B60K 17/04; B60W 10/02; B60K 6/54

(52) U.S. Cl. CPC B60K 6/48; B60K 6/54; B60K 17/04; B60W 10/02; B60L 2240/423; B60W 20/40

(57) ABSTRACT

The invention relates to a method for starting an internal combustion engine of a hybrid vehicle, where an electric motor of the hybrid vehicle is accelerated to a predetermined engine speed and a hybrid disconnect clutch, which is arranged between the internal combustion engine and the electric motor, is moved in the closing direction depending on the set-point clutch torque. In a method which safeguards a high reproducibility of the restart operation, the set-point clutch torque for restarting the internal combustion engine is determined depending on an engine switch-off position of the internal combustion engine in a first phase in which the internal combustion engine is not running.

### BACKGROUND

The invention relates to a method for starting an internal combustion engine in a hybrid vehicle, in which an electric motor of the hybrid vehicle is accelerated to a predetermined engine speed and a hybrid disconnect clutch, arranged between the internal combustion engine and the electric motor, is moved in the closing direction depending on the set-point clutch torque to be transmitted.

A method is known from DE 10 2008 030 480 A1 for controlling a starter clutch, in which the starter clutch is located in the drivetrain of a hybrid vehicle. During the starting phase of the internal combustion engine the starter clutch, arranged between the internal combustion engine and the electric motor, is closed by the electric motor in a first starting phase via a pilot control, and in a second starting phase depending on the acceleration of the crankshaft of the internal combustion engine. Here, the switched-off internal combustion engine is appropriately entrained. This method is not very robust in some situations. The clutch torque is either too strong, i.e. the acceleration of the internal combustion engine occurs too fast, or the clutch torque is too low, causing the starting process to occur too slowly or not at all in extreme cases.

### SUMMARY

The invention is based on the objective to provide a method for starting an internal combustion engine in a hybrid vehicle, which operates robustly and ensures a secure starting process of the internal combustion engine.

According to the invention this objective is attained in that in a first phase, in which the internal combustion engine is switched off, the set-point clutch torque is determined for restarting the internal combustion engine depending on an engine switch-off position of the internal combustion engine. This is advantageous in that the various positions of the pistons of the internal combustion engine are considered when adjusting the set-point clutch torque. This procedure ensures a secure starting of the internal combustion engine, because the adjusted set-point clutch torque varies.

Advantageously the set-point clutch torque comprises friction and/or compression torque due to the engine switch-off position of the internal combustion engine. These friction and/or compression torques are different, based on engine position, and thus require different drag and/or break loose torque for the internal combustion engine, which are considered when adjusting the set-point clutch torque.

Advantageously the friction and compression torques are subject to temperature influences. The set-point clutch torque therefore varies strongly depending on these different parameters and is determined concretely for the respectively present status of the internal combustion engine.

In one variant, in the first phase the set-point clutch torque is superimposed by a portion considering the inertia and the target acceleration of the internal combustion engine. Here, the set-point clutch torque to be adjusted by the clutch is adapted in a targeted fashion to the structural conditions of the internal combustion engine given.

In a further development, in a second phase in which the internal combustion engine is set into motion, the set-point clutch torque is determined depending on a target acceleration of the internal combustion engine deducted from the dynamic torque. This means that in this second phase only the dynamic torque is considered which depends on the inertia and the target acceleration of the internal combustion engine. The consideration of compression and friction torque can be reduced or waived, because the internal combustion engine is already in motion.

Advantageously the set-point clutch torque is controlled based on the target acceleration of the internal combustion engine. This ensures that at any point of time the restart of the internal combustion engine is adjusted to the desired set-point clutch torque and thus the internal combustion engine is further accelerated.

In one embodiment, in a third phase, when the rotational speed difference between the internal combustion engine and the electric motor is lower than the predetermined threshold for the engine speed, the hybrid disconnect clutch is completely closed. This way it is ensured that the internal combustion engine is adjusted as fast as possible to the engine speed of the electric motor.

In another variant, a ramp function of a slip-control is used for the complete closure of the hybrid separating clutch. The ramp function shall here be used preferably, since leaps in engine speed can occur when using the slip-control.

### BRIEF DESCRIPTION OF THE DRAWINGS

The invention allows numerous embodiments. One of them shall be explained in greater detail with the figures shown in the drawing.

Shown are:

FIG. 1 an exemplary embodiment of a drivetrain of a hybrid vehicle,

FIG. 2 compression torques of the internal combustion engine as a function of the crankshaft angle, and

FIG. 3 an exemplary embodiment of the method according to the invention.

### DETAILED DESCRIPTION OF THE PREFERRED EMBODIMENTS

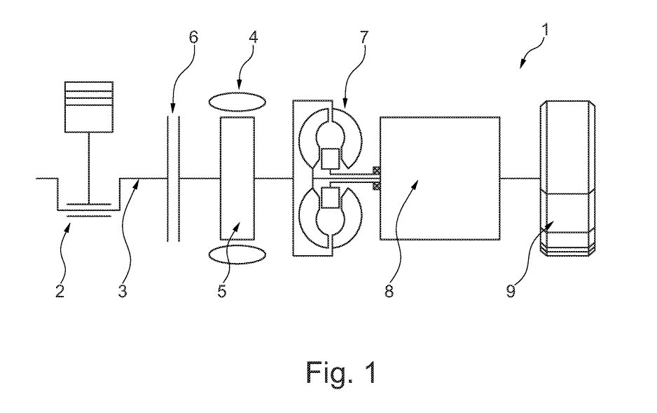

FIG. 1 shows an exemplary embodiment of a drivetrain 1 of a hybrid vehicle with an internal combustion engine 2, which comprises a crankshaft 3. An electric motor 4 comprises a rotor 5, with a hybrid disconnect clutch 6 being arranged between the electric motor 4 and the internal combustion engine 2. Another clutch, embodied in the exemplary embodiment shown as a torque converter 7, which additionally may include a converter lockup clutch, is arranged between the transmission 8 and the electric motor 4. The transmission 8 transfers the drive torque generated by the drive units (internal combustion engine 2 and electric motor 4) individually or jointly to the drive wheels 9. If the internal combustion engine 2 exclusively transmits torque when the hybrid disconnect clutch 6 is closed, the electric motor 4 is set current-less and the rotor 5 serves here as a flywheel. Upon electrification of the electric motor 4 and when the hybrid disconnect clutch 6 is closed both drive units 2, 4 transmit torque to the transmission 8. If only the electric motor 4 shall act as the drive, the hybrid disconnect clutch 6 is opened. If braking is to occur with the electric motor 4, the hybrid disconnect clutch 4 is opened and the electric motor 4 operates as a generator. Additionally, in order to generate a greater braking effect, the drag torque of the internal combustion engine 2 is used by closing the hybrid disconnect clutch 6.

In hybrid vehicles it frequently occurs that after electric driving operation, with the hybrid vehicle being in operation, the switched-off internal combustion engine 2 shall be started in order to this way perform a hybrid drive operation. FIG. 3 shows a diagram illustrating the process of restarting the internal combustion engine 2. In such a restarting process the internal combustion engine 2 is initially switched off, and the hybrid vehicle is operated by an electric motor 4, while the hybrid disconnect clutch 6 is opened. The restarting phase of the internal combustion engine 2 is divided into three phases. In the first phase the electric motor 4 is accelerated to a predetermined engine speed. In order to ensure a secure start of the internal combustion engine 2, starting at zero, an appropriate set-point clutch torque must be generated. The set-point clutch torque to be generated depends here essentially on two components. The first component MkuppPart1 comprises specific features of the internal combustion engine 2, such as the friction and compression behavior. This friction and compression behavior is discernible from the given motor switch-off position of the internal combustion engine 2 when restarting the internal combustion engine 2. The switch-off position of the internal combustion engine 2 is here for example referenced to an absolute angular position, i.e. a clutch torque portion is defined which is dependent on the switch-off position of the motor. The background is here that the closer the piston to the upper dead end, the higher the required clutch torque in order to overcome the compression.

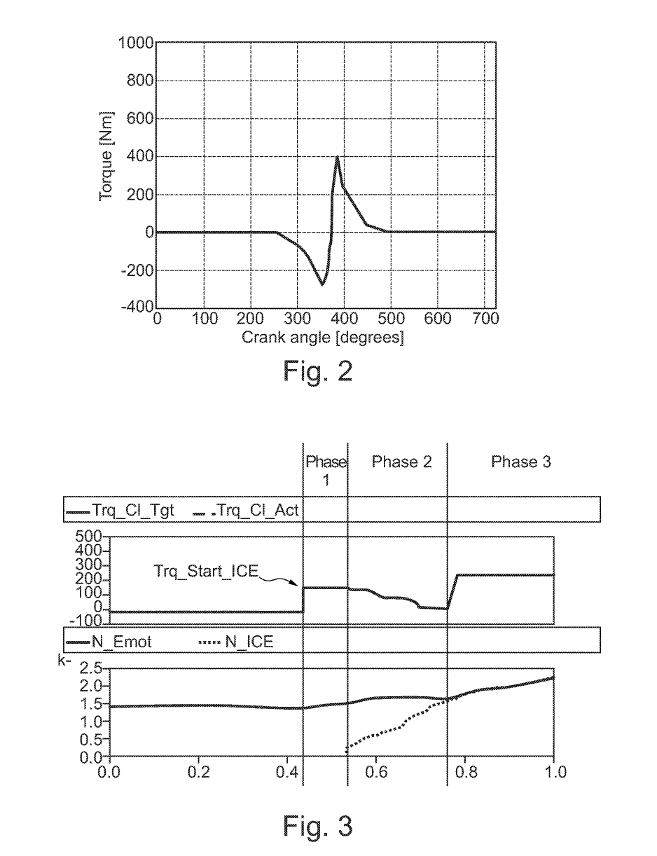

The various motor switch-off positions of the pistons of the internal combustion engine 2 are divided over the crankshaft angle φ into four conditions of the internal combustion engine. FIG. 2 shows the compression torques of the internal combustion engine depending on the crankshaft angle φ. The conditions of the internal combustion engine 2 are here defined as follows:
Suction phase: 0<φ<180°
Compression phase: 180°<φ<360°
Combustion/expansion phase: 360°<φ<540°
Exhaust phase: 540° C.<φ<720°

Depending at what angular crankshaft position the internal combustion engine 2 is set at the time of restart, different friction and compression forces develop, which must be overcome by the set-point clutch torque. Furthermore it is considered that the friction and compression torques are subject to temperature influences.

MkuppPart1=Mstart_eng (φ, temp)

In this phase 1, another second component MkuppPart2 of the set-point clutch torque is considered, which can be called dynamic torque. This dynamic torque determines the dynamic acceleration of the internal combustion engine 2, with this dynamic torque perhaps also being subject to temperature influences and typically being determined based on the following equation

Mkupp2=Jmot*wTgt,

with

Jmot=weight inertia of the internal combustion engine

wTgt=target acceleration of the internal combustion engine in rad/sec.

It can be deducted therefrom that in the first phase the control torque Mkupp of the hybrid disconnect clutch 6 is determined as

Mkupp=Mstart_eng (φ, temp)+Jmot*wTgt,

in which the dynamic torque being superimposed the set-point clutch torque and being provided by the electric motor 3.

In the second phase of the restarting process the internal combustion engine 2 begins to rotate. Here the set-point clutch torque is limited to the dynamic torque, while the friction and compression torque is reduced or completely set to zero. The set-point clutch torque includes only portions to adjust the desired target acceleration of the internal combustion engine 2.

As discernible from FIG. 3, the torque N_Emot of the electric motor 4 increases in phase 2 in order to entrain the internal combustion engine 2. The adjustment of the target acceleration of the internal combustion engine 2 can here be supported by the control unit. It must be observed here that the overall clutch torque towards the end of phase 2, when the torque of the internal combustion engine N_ICE approaches that of the electric motor N_Emot, is as low as possible in order to avoid unnecessary coupling pressures of the hybrid vehicle.

The abbreviations required in FIG. 3 are as follows:
Trq_Cl_Tgt Set-point clutch torque
N_Emot Motor speed of the electric motor
N_ICE Motor speed of the internal combustion engine
Trq_Start_ICE Start set-point clutch torque of the internal combustion engine

At the end of the restarting process in phase 3, with the rotational speed difference between the internal combustion engine N_ICE and the electric motor N_Emot is below a predetermined threshold, the hybrid disconnect clutch 6 is completely closed.

This can be realized, on the one hand in that a ramp function is used in the control system. Alternatively a slip-control is possible, as well.

Based on the suggested solution the restart functionality is optimized in a hybrid vehicle by rendering in the first phase of the restart process the control of the internal combustion engine 2 dependent on its switch-off position. This is advantageous in that this way a secure restart is possible and simultaneously the subsequent acceleration behavior is clearly more reproducible.

### LIST OF REFERENCE CHARACTERS

1 drivetrain

2 internal combustion engine

3 crankshaft

4 electric motor

5 rotor

6 hybrid disconnect clutch

7 torque converter

8 transmission

9 drive wheels

1. A method for starting an internal combustion engine in a hybrid vehicle, comprising accelerating an electric motor of the hybrid vehicle to a predetermined motor speed and moving a hybrid disconnect clutch arranged between the internal combustion engine and the electric motor depending on a set-point clutch torque to be transmitted in a closing direction, and in a first phase in which the internal combustion engine is switched off, determining the set-point clutch torque for restarting the internal combustion engine depending on a motor switch-off position of the internal combustion engine.

2. The method according to claim 1, wherein the set-point clutch torque at least one of includes friction or compression torque due to the motor switch-off position of the internal combustion engine.

3. The method according to claim 2, wherein the friction and compression torques are influenced by temperature.

4. The method according to claim 1, further comprising superimposing the set-point clutch torque by a portion in the first phase, which considers an inertia and a set-point acceleration of the internal combustion engine.

5. The method according to claim 1, further comprising in a second phase, in which the internal combustion engine starts in motion, determining the set-point clutch torque based on a target acceleration of the internal combustion engine deducted from a dynamic torque.

6. The method according to claim 5, wherein the set-point clutch torque is controlled depending on the target acceleration of the internal combustion engine.

7. The method according to claim 5, further comprising in a third phase in which a rotational speed difference of the internal combustion engine and the electric motor is below a predetermined speed threshold, completely closing the hybrid disconnect clutch.

8. The method according to claim 7, wherein a ramp function or a slip-control is used for a complete closing of the hybrid disconnect clutch.
